(19) United States
(12) Patent Application Publication
(10) Pub. No.: US 2026/0293922 A1
(43) Pub. Date: Oct. 1, 2026

(54) A Milk Product Comprising Milk Fat Globule Membranes And A Method For Manufacturing Thereof

(71) Applicant: VALIO LTD, Helsinki (FI)

(72) Inventors: Anu Turpeinen, Helsinki (FI); Timo Sibakov, Helsinki (FI); Antti Heino, Helsinki (FI); Kaity-Marin Lehtonen, Helsinki (FI); Olli Matilainen, Helsinki (FI)

(21) Appl. No.: 19/482,979

(22) PCT Filed: May 10, 2024
(86) PCT No.: PCT/FI2024/050225

§ 371 Date: Nov. 10, 2025

(30) Foreign Application Priority Data
May 12, 2023 (FI) 20235540

(51) Int. Cl. A23C 9/142; A23C 9/18; A23C 17/00

(52) U.S. Cl. CPC A23C 9/1422; A23C 9/18; A23C 17/00; A23C 2210/202; A23C 2240/05

(57) ABSTRACT

The present disclosure relates to a milk product, a method for producing the milk product, use of the milk product and dairy based products comprising the milk product. The present disclosure also relates to a method of improving or maintaining physical performance in a subject as well as a milk product or a dairy based food product for use in improving or maintaining physical performance in a subject.

### FIELD OF THE DISCLOSURE

The present disclosure relates to a milk product, and particularly to a milk product having special nutritive values based on its composition. The present disclosure further concerns a method for producing the milk product, use of the milk product and dairy based products comprising the milk product. The present disclosure also relates to a method of improving or maintaining physical performance in a subject as well as a milk product or a dairy based food product for use in improving or maintaining physical performance in a subject.

### BACKGROUND OF THE DISCLOSURE

Good physical performance is central for wellbeing and particularly for active and healthy aging. Physical performance relates not only to the musculoskeletal system, but also to other aspects of daily living. For example, prevalence of sarcopenia increases with aging, especially in people >70 years. Sarcopenia can be defined as low muscle strength, mass and quality. Severe sarcopenia additionally includes poor physical performance. Loss of muscle mass is associated with factors including malnutrition, low protein intake, low physical activity, unintentional weight loss and low body mass index. As the world's population is aging, there is a need to find feasible interventions to counteract these impairments.

Milk's favourable influence on mammals' health is widely recognized and established. For example, a strong reverse correlation has been observed between regular and high consumption of milk products and the development of metabolic syndrome in overweight adults. Also, milk is an outstanding source of calcium which can contribute to proper bone formation and bone health maintenance. Milk is not consumed only for its nutritive value but milk has established itself as a beverage commonly consumed at daily meals among humans of all ages.

Milk comprises milk protein in rich amounts. Milk protein is nutritionally a good natural source of protein. Protein is needed in the diet because as an important building block of body tissue it is required to repair and build new tissue. Milk protein absorbs well in the gut and contains all amino acids essential for the body.

Milk fat globule membrane (MFGM) is a complex structure in milk composed primarily of lipids and proteins that surround fat globules in mammal milk. It is a source of multiple bioactive compounds, including phospholipids, glycolipids and glycoproteins, that may have important functional roles within the brain and gut. It is found to be antimicrobial, anti-inflammatory, anti-cholesterolemic and safe to use as a supplement.

Thus, milk contains a variety of components having excellent nutritive value but which have not to date been utilized to their fullest potential. There is a constant and longstanding need to develop milk products that take advantage of milk components to provide novel nutritive compositions that help improve physical performance in humans.

### BRIEF DESCRIPTION OF THE DISCLOSURE

An object of the present disclosure is to provide a milk product having a high content of both milk protein and MFGM so as to solve the above problems. Particularly, the milk product has a content of milk protein in dry matter of at least 30% by weight and a content of MFGM in dry matter of at least 3% by weight. It is also provided a dairy based food product comprising the milk product and use of the milk product for manufacturing a dairy based food product. It is also provided a method for manufacturing the milk product, a milk product manufactured by said method and a dairy based food product manufactured from the milk product.

The object of the disclosure is achieved by a milk product, a dairy based food product, a use and a method which are characterized by what is stated in the independent claims. The preferred embodiments of the disclosure are disclosed in the dependent claims.

### BRIEF DESCRIPTION OF THE DRAWINGS

In the following the disclosure will be described in greater detail by means of preferred embodiments with reference to the accompanying drawings, in which

FIG. 1 shows an exemplary process according to the disclosure;

FIG. 2 shows an exemplary process according to the disclosure;

FIG. 3 shows a flow-chart of the clinical study described in Example 3; and

FIG. 4 illustrates the beneficial effects of MFGM-containing powders on C. elegans activity upon aging and proteotoxicity. A) Activity of day 4 adult (day 7 from hatch) wild-type (N2) animals treated with Ctrl, Protein powder 1 and Protein powder 2. B) Activity of day 2 adult Aβ₁₋₄₂ strain (GMC101) treated with Protein powder 1 and Protein powder 2 compared to Ctrl-treated Aβ₁₋₄₂- and Control (CL2122) strains. In A and B, Protein powder 1 and Protein powder 2 were dissolved in H₂O (1 mg/ml) and spread on top of NGM agar (2 ml of powder solution to 10 cm NGM agar plate). H₂O was used as a control. After the plates had dried, E. coli OP50 was added as a food source. C. elegans activity was measured in 96-well plates using wMicroTracker. Each dot represents a group of 10 animals (n=240 (A) and n=120 (B) animals per condition, *p<0.05, ****p<0.0001, one-way ANOVA with Tukey's test).

### DETAILED DESCRIPTION OF THE DISCLOSURE

As used herein, the term “milk product” refers to a product of milk origin, comprising milk protein. The term “milk product” may thus originate from milk raw material such as milk, and combinations of milk and whey as such or as a concentrate or pretreated in a desired manner, such as heat-treated. The milk product may be supplemented with ingredients generally used in the preparation of dairy based food products, such as fat, protein, ash (minerals), or sugar fractions, or the like. The milk product or the milk raw material used to manufacture the milk product may be treated by e.g. lactose removal. The milk product may thus originate from a milk raw material such as, for instance, buttermilk, full-fat milk, cream, low-fat milk, ultrafiltered milk, diafiltered milk, microfiltered milk, whey protein depleted milk, recombined milk from milk powder, organic milk or a combination of these, or a dilution of any of these. Milk raw material and milk product may originate from a cow, sheep, goat, camel, horse or any other animal producing milk suitable for nourishment. Herein, the milk product particularly contains both milk protein and MFGM. In other words, the milk product according to the disclosure is manufactured from a milk raw material comprising both milk protein and MFGM.

As used herein, the terms “milk protein” and “protein” may be used interchangeably.

As used herein, the terms “dairy based food product”, “dairy-based food product” and the like refer to a product comprising a component of milk origin. For instance, the dairy based food product may comprise or be manufactured from or using the milk product according to the present disclosure.

As used herein, the terms “lactose free”, “lactose-free” and the like refer to that lactose content of the milk product is not more than 0.5 g/serving (e.g. for liquid milk products not more than 0.5 g/244 g, the lactose content being at most 0.21%), however not more than 0.5% (w/w). Lactose can be removed from milk in any manner known in the art, such as by membrane techniques using one or more various membrane filtrations including microfiltration, ultrafiltration, nanofiltration, diafiltration and reverse osmosis, by lactose hydrolysis, chromatography, precipitation, or any combination of these in one or more phases. Any lactase enzyme for lactose hydrolysis known in the art can be used.

As used herein, the terms “butter milk”, “buttermilk”, “butter serum” and the like refer to a liquid product obtained upon churning of cream to produce butter. When butter is churned, milk fat globules in cream are broken down, and MFGM is released into liquid portion of the cream. This liquid is then separated from the solid butter and is commonly referred to as butter serum or buttermilk. Butter serum can contain a significant amount of MFGM, making it a potential source of MFGM for food products that require this ingredient. Cream is produced by separating a milk raw material such as raw milk into cream and skim milk. The fatty cream may then be churned into butter and buttermilk. The typical composition of lactose-free buttermilk is: dry matter 9 wt-%, protein 3 wt-%, lactose <0.01 wt-%, ash 0.7 wt-%, fat 0.6 wt-%, phospholipids in the range of 0.1 to 0.15 wt-%. Typically, buttermilk has a fat content of 0.5 to 2.5 wt-% and a dry matter content of 8 to 11 wt-%. The composition of buttermilk differs from skim milk in that it contains MFGM components such as phospholipids, sphingolipids and glycoproteins. Lactose-free buttermilk is produced when lactose free butter is churned from lactose free cream. In the process of producing lactose free butter raw milk is typically first enzymatically treated to hydrolyze lactose into monosaccharides, and then the enzymatically lactose hydrolyzed cream is churned into butter and buttermilk.

In an aspect, the disclosure relates to a milk product having a high content of both milk protein and MFGM. Particularly, the milk product has a content of milk protein in dry matter of at least 30% by weight and a content of MFGM in dry matter of at least 3% by weight. Optionally, the milk product may have a lactose content of less than 1% by weight, preferably less than 0.1% by weight, more preferably less than 0.01% by weight.

We have surprisingly found out that a milk product containing MFGM and protein provides a nutritional composition having special nutritive value. MFGM supplementation may stimulate neuromuscular junction development, which is a critical structure of motor units involved in physical movement. An increase in active motor units may lead to improvement in physical function such as improved ambulatory activities, physical agility, leg muscle mass, and muscle fiber velocity.

In a further aspect, the milk protein comprised in the milk product may be partially hydrolysed. Hydrolysis of milk protein may be achieved in any manner known in the art. Any suitable protease enzyme can be used in the hydrolysis. Enzymatic degradation of protein with enzymes obtained from generally known enzyme sources such as plants and microorganisms is generally known in the field, the process comprising a step of adding one or more protease enzymes or mixtures thereof to milk in such a manner that protein is degraded to peptides or amino acids or both.

In a 12-week randomized controlled trial on older women (≥70 years) that is described herein, study participants were offered a dairy based food product high in both MFGM and hydrolysed milk protein. As many older people consume less than the recommended amount of protein, the purpose of the study was to test whether a dairy based food product high both in MFGM and hydrolysed milk protein would improve physical performance of older women with lower than recommended protein intake at baseline. As a result, in the Short Physical Performance Battery (SPPB) test, the total SPPB score differed significantly between the control and intervention group, favouring the intervention group (p=0.020). Of SPPB, the balance test showed the largest difference. Protein intake increased significantly in the intervention group (+14 g) compared to the control group (−1 g). The results indicate that the combination of MFGM and protein may improve physical performance related balance of older women. In particularly older people, both sarcopenia and frailty increase risk of mobility disability, falls, poor physical function and decline in quality of life, institutionalization, and premature death. Improved physical performance will help alleviate or overcome these impairments.

The observation of improved physical performance in humans is corroborated by experiments with the nematode Caenorhabditis elegans which is a widely used model organism in aging research due to its conserved genome and proteome, as well as the occurrence of age-related human-like physiological changes at the tissue, cellular, and molecular level. The data reported herein demonstrates that dairy based products (protein powder) high in both MFGM and hydrolysed milk protein enhance the physiological activity in C. elegans.

Without being limited to any one theory, it is believed that consuming a milk product having a high content of both (milk) protein and MFGM improves physical function. Insufficient intake of energy and protein may accelerate muscle loss, whereas sufficient protein and MFGM intake may suppress deterioration of muscle mass and strength, particularly age-associated deterioration of muscle mass and strength in older people. It is also believed that this effect is synergistic, as MFGM supplementation and increased availability of amino acids from protein may together stimulate neuromuscular junction development, 25 providing a combined effect that is greater than the sum of individual effects of MFGM and protein.

We have further observed that the milk proteins present in the milk product can be hydrolysed partially to produce a protein hydrolysed milk product. The physical function improving effect of the milk product may be even further pronounced when the protein is partially hydrolysed. Hydrolysed milk protein is absorbed more rapidly than intact protein, further increasing postprandial amino acid availability. This may augment postprandial muscle protein synthetic response particularly in older people, leading to improved physical performance.

In the present disclosure, protein hydrolysis of milk can be accomplished in any manner known in the art. Any suitable protease enzyme can be used in the hydrolysis. Enzymatic degradation of protein with enzymes obtained from generally known enzyme sources such as plants and microorganisms is generally known in the field, the process comprising a step of adding one or more protease enzymes or mixtures thereof to milk in such a manner that protein is degraded to peptides or amino acids or both. For example, suitable enzymes in the protein hydrolysis in the present disclosure are Alcalase 2.4 L FG protease (Novozymes Inc., Denmark) and Flavourzyme 1000 L (Novozymes Inc., Denmark) and their mixture.

In an aspect, extent of protein hydrolysis in the milk product is at least 2 mg free tyrosine/g protein. Preferably, the extent of protein hydrolysis in the milk product is at least 3 mg free tyrosine/g protein, more preferably at least 4 mg free tyrosine/g protein. In further embodiments the extent of protein hydrolysis in the milk product is at least 5 mg, 6 mg, 7 mg, 8 mg, 9 mg, 10 mg, 11 mg, 12 mg, 13 mg, 14 mg, 15 mg, 20 mg, 25 mg, 30 mg, 35 mg, 40 mg, 45 mg, or 48 mg free tyrosine/g protein but no more than 50 mg free tyrosine/g protein. In further embodiments the extent of protein hydrolysis in the milk product is at least 2 mg of free tyrosine/g protein but no more than 5 mg, 6 mg, 7 mg, 8 mg, 9 mg, 10 mg, 11 mg, 12 mg, 13 mg, 14 mg, 15 mg, 20 mg, 25 mg, 30 mg, 35 mg, 40 mg, 45 mg, 48 mg or 50 mg free tyrosine/g protein.

In an aspect, the degree, or extent, of protein hydrolysis of the milk product is between 2 mg and 15 mg of free tyrosine per gram of protein. In another aspect, the degree, or extent, of protein hydrolysis of the milk product is between 5 mg and 50 mg, or between 2 mg and 50 mg or between 2 mg and 40 mg of free tyrosine per gram of protein. Said free tyrosine range equals a low degree of proteolysis.

The extent of protein hydrolysis in the milk product may be measured according to the modified method of Matsubara et al. (1958). The soluble tyrosine content is obtained from the method of Matsubara as mg tyrosine/litre of the milk product. This is then converted to mg tyrosine/g protein by determining protein content/litre of the milk product.

In an aspect, the milk product according to the disclosure may have a MFGM to protein weight ratio in the range of about 0.05 to about 0.4, preferably about 0.1 to about 0.3.

In a further aspect, in the milk product according to the disclosure the content of milk protein in dry matter is in the range of 30% to 90% by weight, preferably in the range of 35% to 90% by weight, more preferably in the range of 35% to 80% by weight, most preferably in the range of 40% to 80% by weight. Additionally or alternatively, the content of MFGM in dry matter is in the range of 3% to 30% by weight, preferably in the range of 4% to 30% by weight, more preferably in the range of 4% to 25% by weight, most preferably in the range of 5% to 25% by weight.

It is to be understood that together, components of the milk product such as milk protein, MFGM and optionally lactose may make up a maximum total of 100% by weight of dry matter.

In a yet further aspect, the milk product according to the disclosure may have a protein to ash weight ratio in the range of about 3.0 to about 25, preferably about 5.0 to about 20. Additionally or alternatively, the milk product according to the disclosure may have a MFGM to ash weight ratio of about 0.6 to about 10, preferably about 1.0 to about 5.0. The amount of ash reflects the mineral content of the milk product. Mineral content has an effect on the flavour properties of the milk product, and the disclosed ranges of protein to ash and MFGM to ash weight ratios impart a pleasant flavour to the milk product.

In an aspect, the milk product according to the disclosure may have a protein to fat weight ratio in the range of about 3 to about 10, preferably about 4 to about 6. The disclosed ranges of protein to fat weight ratios give good organoleptic properties to the milk product.

Said contents of any one or more of milk protein in dry matter, MFGM in dry matter, weight ratios of MFGM to protein, protein to ash, and MFGM to ash provide(s) a milk product which, as discussed above, has excellent nutritive value. Consuming the product may provide increased satiety, stabilized blood sugar, reduced craving for sugar, and aid in controlling weight. The milk product also has good organoleptic properties and a pleasant flavour and is well tolerated upon consumption and digestion.

The nutritive value originates from MFGM present in the milk raw material and the milk product produced from it. Also, the nutritive value originates from milk protein which is abundantly present in the milk product. Together, MFGM and protein are believed to have a synergistic effect having both a physiological and a compositional basis. The physiological basis of synergy, which relates to MFGM supplementation and increased availability of amino acids from protein, is discussed above.

Compared to e.g. conventional dairy products, the milk product according to the disclosure has a high content of MFGM and protein. Also, compared to conventional dairy products the milk product has a lower amount of off-flavours or is essentially free of off-flavours. This effect of improved taste is particularly pronounced in case a lactose-free milk raw material is used to produce the milk product.

Also, compared to conventional dairy products, the milk product according to the disclosure has a reduced amount of carbohydrates such as monosaccharides. This improves processability of the milk product as it for example provides improved properties in heat treatment of the milk product by reducing or preventing browning caused by Maillard reaction. This facilitates easier drying of the milk product. Also, occurrence of Maillard reaction may have an adverse effect on protein functionality and digestibility. Therefore, a reduced amount of Maillard reaction in the milk product also provides a compositional basis for the synergistic effect of the milk product.

In an aspect, a carbohydrate to protein weight ratio of the milk product according to the disclosure is about 0.9 or less. Preferably, the carbohydrate to protein weight ratio of the milk product is in the range of 0.01 to 0.9, more preferably 0.01 to 0.5, most preferably 0.02 to 0.4. The carbohydrate to protein weight ratio of the milk product may be at least 0.01, 0.02, 0.03, 0.04, 0.05, 0.06, 0.07, 0.08, 0.09, 0.1, 0.15, 0.2, 0.25, or 0.3. Additionally or alternatively, the carbohydrate to protein weight ratio of the milk product may be up to 0.4, 0.5, 0.6, 0.7, 0.8 or 0.9.

In addition, protein hydrolysis reduces viscosity of the milk product. This provides benefits to the product, facilitating easier processing of the milk product as it is less likely to attach to and accumulate on instrumentation surfaces such as heat exchange surfaces. On a heated surface, a deposit of the milk product components may become parched and cause undesirable changes in flavour. Also, reduced viscosity makes the milk product easier to consume and/or imbibe and may enhance adsorption of milk product components in the gut. This may further add to the compositional basis of the synergistic effect as enhanced palatability and adsorption improve availability of MFGM and amino acids.

Due to its improved flavor profile and processability properties, the milk product according to the disclosure can be used as a milk raw material in manufacture of all kinds of dairy based food products including powders, milk-based drinks, sour milk products and/or acidified fresh products. In other words, or alternatively, said dairy based food products comprise the milk product according to the disclosure. The dairy based food products include protein powder, milk shake, dairy shot drink, yoghurt, fermented milk, viili, fermented cream, sour cream, crème fraiche, quark, and kefir.

Thus, in an aspect, the disclosure relates to a dairy based food product manufactured from or comprising the milk product according to the disclosure. The dairy based food product may comprise at least 20% (w/w) of the milk product, preferably at least 30% (w/w), more preferably at least 40% (w/w), most preferably at least 50% (w/w).

In another aspect, the disclosure relates to use of the milk product according to the disclosure for manufacturing a dairy based food product. The dairy based food product may be selected from a powder, a milk-based drink, a sour milk product and/or an acidified fresh product. The dairy based food product may be a protein powder, milk shake, dairy shot drink, yoghurt, fermented milk, viili, fermented cream, sour cream, crème fraiche, quark or kefir.

We have surprisingly found that buttermilk produced from milk material such as cream separated from raw milk, can successfully be used as milk raw material for manufacture of the milk product according to the disclosure. Buttermilk typically cannot be used efficiently for the production of traditional dairy products such as yoghurt and cheese due to development of off-flavours such as rancid taste and/or bitter taste. This effect may be particularly pronounced when buttermilk has been produced through churning a normal, non-lactose hydrolysed cream. Removal of lactose before separation of cream and/or churning of cream may reduce the development of off-flavours.

Thus, in an embodiment, the milk product according to the disclosure is manufactured from buttermilk, preferably lactose-free buttermilk. In other words, buttermilk or lactose-free buttermilk is used as milk raw material for the milk product.

In yet another aspect, the disclosure relates to a method of producing a milk product having a high content of both milk protein and MFGM. Particularly, the milk product has a content of milk protein in dry matter of at least 30% by weight and a content of MFGM in dry matter of at least 3% by weight. Optionally, the milk product may have a lactose content of less than 1% by weight, preferably less than 0.1% by weight, more preferably less than 0.01% by weight. The method comprises the steps of subjecting a milk raw material comprising both milk protein and MFGM to ultrafiltration and collecting an ultrafiltration retentate.

It is to be understood that together, components of the milk product such as milk protein, MFGM and optionally lactose may make up a maximum total of 100% by weight of dry matter.

Any method known in the art to measure MFGM concentration may be used. Here, polar lipids were analysed according to Jukkola et al. 2019 and MFGM concentration was calculated by multiplying the concentration of polar lipids by three.

In an aspect, in the method according to the disclosure, ultrafiltration comprises a step of diafiltration. In diafiltration, it is possible to use tap water or fractions from different membrane processes of milk, such as a permeate or a retentate, a chromatographically separated fraction or a combination of these, or a dilution of any of these. Diafiltration medium (diawater) can also originate from separate processes. In diafiltration, small-sized molecules such as monosaccharides and univalent minerals are removed into the permeate, whereas larger-sized molecules such as proteins and lipids, including MFGM, are maintained in the retentate. Also, calcium mainly remains associated with proteins. Ultrafiltration including diafiltration is a gentle separation method which maintains integrity of MFGM globules and keeps their size distribution stable. The increase in protein content and decrease in monosaccharide content provides a milk product that is easy to dry.

In an aspect, in the method according to the disclosure, lactose removal is accomplished prior to, during and/or subsequent to ultrafiltration. In other words, lactose removal is accomplished i) prior to ultrafiltration, ii) during ultrafiltration, iii) subsequent to ultrafiltration, or iv) any combination of any two or more of i) to iii). That is, the milk raw material used in the method may be lactose-free. Alternatively, lactose removal may be performed to the milk raw material before ultrafiltration or to the retentate collected from ultrafiltration. Lactose removal may be performed during ultrafiltration in such a manner that lactose is hydrolyzed prior to ultrafiltration and the resulting monosaccharides are removed into the permeate. Alternatively, ultrafiltration may be designed in such a manner that lactose is removed into the permeate without prior hydrolysis. Manners of removing lactose from a milk product are known in the art and may be employed by skilled persons to achieve a lactose-free milk product. Alternatively, in lactose removal accomplished during and subsequent to ultrafiltration, lactose partially passes into ultrafiltration permeate and lactose retained in the ultrafiltration retentate is subjected to enzymatic hydrolysis. In an aspect, the method according to the disclosure further comprises a step of partially hydrolysing the milk proteins comprised in the ultrafiltration retentate. Optionally, protein hydrolysis may be accomplished simultaneously with lactose removal in case lactose is hydrolysed subsequent to ultrafiltration.

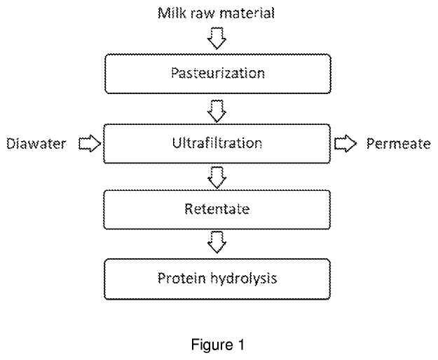

FIG. 1 summarizes an exemplary method according to the disclosure. In FIG. 1, milk raw material is pasteurized and subjected to ultrafiltration comprising diafiltration. The retentate is treated by protein hydrolysis to achieve hydrolysis of a part of the milk protein. The protein hydrolysis step may optionally include lactose hydrolysis to achieve a lactose-free product.

In an aspect, extent of protein hydrolysis in the method is at least 2 mg free tyrosine/g protein. Preferably, the extent of protein hydrolysis is at least 3 mg free tyrosine/g protein, more preferably at least 4 mg free tyrosine/g protein. In further embodiments the extent of protein hydrolysis is at least 5 mg, 6 mg, 7 mg, 8 mg, 9 mg, 10 mg, 11 mg, 12 mg, 13 mg, 14 mg, 15 mg, 20 mg, 25 mg, 30 mg, 35 mg, 40 mg, 45 mg, or 48 mg free tyrosine/g protein but no more than 50 mg free tyrosine/g protein. In further embodiments the extent of protein hydrolysis is at least 2 mg of free tyrosine/g protein but no more than 5 mg, 6 mg, 7 mg, 8 mg, 9 mg, 10 mg, 11 mg, 12 mg, 13 mg, 14 mg, 15 mg, 20 mg, 25 mg, 30 mg, 35 mg, 40 mg, 45 mg, 48 mg or 50 mg free tyrosine/g protein.

In an aspect, the degree, or extent, of protein hydrolysis is between 2 mg and 15 mg of free tyrosine per gram of protein. In another aspect, the degree, or extent, of protein hydrolysis is between 5 mg and 50 mg, or between 2 mg and 50 mg or between 2 mg and 40 mg of free tyrosine per gram of protein.

In an aspect, in the method according to the disclosure, protein hydrolysis is performed until extent of protein hydrolysis is at least 2 mg tyrosine/g protein, preferably at least 3 mg/g protein. Soluble tyrosine content may be measured according to the modified method of Matsubara et al. (1958) as described above.

In a further aspect, in the method according to the disclosure, the milk product has a MFGM to protein weight ratio in the range of about 0.05 to about 0.4, preferably about 0.1 to about 0.3.

In a yet further aspect, in the method according to the disclosure, the content of protein in dry matter is in the range of 30% to 90% by weight, preferably in the range of 35% to 90% by weight, more preferably in the range of 35% to 80% by weight, most preferably in the range of 40% to 80% by weight. Additionally or alternatively, the content of MFGM in dry matter is in the range of 3% to 30% by weight, preferably in the range of 4% to 30% by weight, more preferably in the range of 4% to 25% by weight, most preferably in the range of 5% to 25% by weight.

It is to be understood that together, components of the milk product such as milk protein, MFGM and optionally lactose may make up a maximum total of 100% by weight of dry matter.

In a still further aspect, in the method according to the disclosure, the milk product has a protein to ash weight ratio in the range of about 3.0 to about 25, preferably about 5.0 to about 20. Additionally or alternatively, the milk product has a MFGM to ash weight ratio of about 0.6 to about 10, preferably about 1.0 to about 5.0.

In a yet further aspect, in the method according to the disclosure, the milk product has a protein to fat weight ratio in the range of about 3 to about 10, preferably about 4 to about 6.

In the method according to the disclosure, the milk raw material may be buttermilk or lactose-free buttermilk. Also, the milk raw material of the milk product of the disclosure may be buttermilk or lactose-free buttermilk.

In an aspect, the milk raw material of the milk product of the disclosure or used in the method of the disclosure is buttermilk. Suitable buttermilk originates from churning of sweet cream i.e. noncultured cream when the resulting buttermilk is sweet buttermilk. Suitable buttermilk also originates from churning of cultured cream when the resulting buttermilk is cultured cream buttermilk.

In another aspect, the milk raw material of the milk product of the disclosure or used in the method of the disclosure is lactose free buttermilk. In one embodiment of the disclosure the raw material is lactose free buttermilk, optionally comprising about 9 wt-% dry matter, about 3 wt-% protein, <0.01 wt-% lactose, 0.7 wt-% ash, 0.6 wt-% fat, and phospholipids in the range of 0.1 to 0.15 wt-%.

According to a further embodiment, the milk raw material of the milk product of the disclosure or used in the method of the disclosure is buttermilk comprising protein in the range of 31.5 to 35.5% (w/w) in dry matter, lactose in the range of 48.5 to 53.8% (w/w) in dry matter, fat in the range of 5.5 to 27% (w/w) in dry matter, and milk polar lipids in the range of 1.1 to 6.7% (w/w) in dry matter.

It is to be understood that together, components of the milk product such as milk protein, lactose and milk polar lipids may make up a maximum total of 100% by weight of dry matter.

According to a yet further embodiment, the milk raw material of the milk product of the disclosure or used in the method of the disclosure is buttermilk comprising protein in the range of 31.5 to 35.5% (w/w) in dry matter, lactose in the range of 48.5 to 53.8% (w/w) in dry matter, fat in the range of 5.5 to 13.1% (w/w) in dry matter, and milk polar lipids in the range of 1.1 to 2.1% (w/w) in dry matter.

It is to be understood that together, components of the milk product such as milk protein, lactose, fat and milk polar lipids may make up a maximum total of 100% by weight of dry matter.

According to a still further embodiment, the milk raw material of the milk product of the disclosure or used in the method of the disclosure is lactose free buttermilk comprising protein in the range of 31.5 to 35.5% (w/w) in dry matter, carbohydrates (mainly monosaccharides) in the range of 48.5 to 53.8% (w/w) in dry matter, fat in the range of 5.5 to 27% (w/w) in dry matter and milk polar lipids in the range of 1.1 to 6.7% (w/w) in dry matter.

It is to be understood that together, components of the milk product such as milk protein, carbohydrates, fat and milk polar lipids may make up a maximum total of 100% by weight of dry matter.

According to a yet further embodiment, the milk raw material of the milk product of the disclosure or used in the method of the disclosure is lactose free buttermilk comprising protein in the range of 31.5 to 35.5% (w/w) in dry matter, carbohydrates (mainly monosaccharides) in the range of 48.5 to 53.8% (w/w) in dry matter, fat in the range of 5.5 to 13.1% (w/w) in dry matter and milk polar lipids in the range of 1.1 to 2.1% (w/w) in dry matter.

It is to be understood that together, components of the milk product such as milk protein, carbohydrates, fat and milk polar lipids may make up a maximum total of 100% by weight of dry matter.

It is also disclosed a milk product manufactured by or obtainable by the method disclosed herein. In another aspect, it is disclosed a dairy based food product comprising said milk product or manufactured from said milk product manufactured by or obtainable by the method disclosed herein. The dairy based food product may comprise at least 20% (w/w) of the milk product, preferably at least 30% (w/w), more preferably at least 40% (w/w), most preferably at least 50% (w/w).

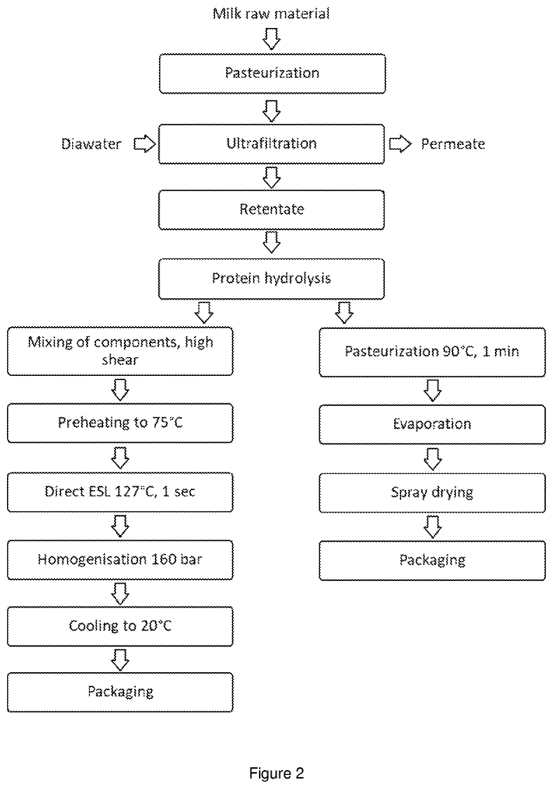

By way of example, FIG. 2 summarizes exemplary methods according to the disclosure to produce dairy based food products from the milk product. Further components may be mixed with the milk product, and the mixture is treated to achieve extended shelf life (ESL) for the food product, homogenized and packaged. Alternatively, the milk product may be dried to a powder. Any method of drying known in the art may be used as a means to this end. Example 2 gives further details of exemplary dairy based food products.

Thus, in an aspect, the method according to the disclosure further comprises subjecting the ultrafiltration retentate to extended shelf life (ESL) treatment and homogenisation to produce a dairy based food product.

In a further aspect, the method according to the disclosure further comprises subjecting the ultrafiltration retentate to evaporation and/or spray drying to produce a powder.

In a yet further aspect, the present disclosure relates to a milk product or a dairy based food product manufactured from the milk product or a dairy based food product comprising the milk product for use in improving or maintaining physical performance in a subject. Said milk product comprises a content of milk protein in dry matter of at least 30% by weight and a content of milk fat globule membrane (MFGM) in dry matter of at least 3% by weight.

In another aspect, the present disclosure relates to a method of improving or maintaining physical performance in a subject. The method comprises administering to the subject a milk product or a dairy based food product manufactured from the milk product or a dairy based food product comprising the milk product. Said milk product comprises a content of milk protein in dry matter of at least 30% by weight and a content of milk fat globule membrane (MFGM) in dry matter of at least 3% by weight.

Without repeating them here, all aspects of the milk product disclosed above also apply to the milk product or a dairy based food product manufactured from the milk product or a dairy based food product comprising the milk product for use in improving or maintaining physical performance in a subject as well as to the method of improving or maintaining physical performance in a subject. These aspects of the milk product include those related to lactose content, hydrolysis and extent of hydrolysis, MFGM to protein weight ratio, content of milk protein in dry matter, content of MFGM in dry matter, protein to ash weight ratio, MFGM to ash weight ratio, protein to fat weight ratio and carbohydrate to protein weight ratio.

The subject is preferably a human subject, although the milk product is suitable also for animals including domesticated animals, pets, livestock and beasts of burden. The human subject may be an elderly human of at least 65 or 70 or 75 years of age or an adult human of at least 18 or 20 or 25 years of age.

Herein, improving or maintaining physical performance comprises one or more of a) to h):
a) Improving or maintaining mobility,
b) Improving or maintaining balance,
c) Improving or maintaining ambulatory activity,
d) Improving or maintaining physical agility,
e) Alleviating or preventing sarcopenia,
f) Improving or maintaining one or more of muscle strength, muscle mass, muscle density, muscle function, and muscle fiber velocity,
g) Improving or maintaining weight control, or
h) Alleviating or reducing the risk of one or more of mobility disability, falling, poor physical function, deterioration of muscle mass, deterioration of strength, decline in quality of life, institutionalization, and premature death.

As used herein, the term “or” has the meaning of both “and” and “or” (i.e. “and/or”). Furthermore, the meaning of a singular noun includes that of a plural noun and thus a singular term, unless otherwise specified, may also carry the meaning of its plural form. In other words, the term “a” or “an” may mean one or more.

As used herein, the term “comprising” includes the broader meanings of “including”, “containing”, and “comprehending”, as well as the narrower expressions “consisting of” and “consisting only of”.

The following examples are illustrative of embodiments of the present disclosure, as described above, and they are not meant to limit the disclosure in any way. The disclosure is illustrated also with reference to the figures.

### EXAMPLES

### Example 1

Production of Milk Product with High Protein and High MFGM Content

Lactose-free buttermilk was obtained from churning of lactose-free cream into butter and buttermilk. Lactose-free cream had been pasteurized and treated with lactase until lactose content was below 0.5% (w/w).

Lactose-free buttermilk was pasteurized (79° C., 180 sec) and treated by ultrafiltration comprising diafiltration to obtain a permeate and a retentate. The process flowchart is presented in FIG. 1. Diafiltration is a technique using ultrafiltration and addition of diawater to lower the concentration of small-molecule components in a solution containing larger biomolecules. The diafiltration permeate contains univalent mineral ions and monosaccharides. Removing these small-molecule components from buttermilk acts for example to reduce or eliminate off-flavours. The diafiltration retentate is a protein concentrate comprising milk proteins and MFGM. The diafiltration retentate was subjected to protein hydrolysis (typically 6° C., 23 h) with proteases. The resulting milk product was a lactose-free partially protein hydrolysed, high protein, high MFGM product.

Protein hydrolysis was undertaken according to patent EP 2632277B1 and was controlled so that the degree of protein hydrolysis was 4.3 mg free tyrosine/g protein as analysed according to the modified method of Matsubara et al. (1958). Alcalase 2.4 L FG protease (Novozymes Inc., Denmark) together with Flavourzyme 1000 L (Novozymes Inc., Denmark) were the proteases used. Analysis was performed for samples which were boiled for 4 min at 100° C. and centrifuged. Soluble tyrosine was determined for the supernatant after centrifugation (3000 rcf, 15 min). The tyrosine content is obtained from the method of Matsubara as mg tyrosine/litre of the milk raw material. This is then converted to mg tyrosine/g protein by determining protein content/litre of the milk raw material.

### Example 2

### The Milk Product as Ingredient of Dairy Based Food Products

The high protein, high MFGM milk product according to Example 1 was further processed to two types of dairy based food products, a milk shake and a protein powder. The process flowchart is described in FIG. 2.

Milk shake was prepared from the following components: 91.5 wt-% the high protein and high MFGM milk product of Example 1; 6.5 wt-% sugar (saccharose); 1.6 wt-% cocoa powder, 0.067 wt % salt, 0.02 wt-% carrageenan, 0.3 wt-% flavours. The components were combined and subjected to high shear mixing. Thereafter, the mixture was preheated to 75° C., subjected to direct extended shelf life (ESL) treatment (127° C., 1 sec), homogenized at a pressure of 160 bar and cooled to 20° C. to provide a milk shake product ready for packaging.

Protein powder was prepared by subjecting the high protein and high MFGM milk product of Example 1 to pasteurization (90°, 1 min), evaporation and spray drying to provide a protein powder product ready for packaging.

Compositions of both dairy based food products were analysed. The results and the analysis methods are presented in Table 1. Polar lipids were analysed according to Jukkola et al. 2019. MFGM concentration was calculated by multiplying the concentration of polar lipids by three. Amount of carbohydrates was calculated by decreasing the amount of fat, ash and protein from dry matter. The content of protein in dry matter by weight in the milk shake was 45.9% and in the protein powder 74.0%. The content of MFGM in dry matter by weight in the milk shake was 7.1% and in the protein powder 15.7%. The weight ratio of MFGM to protein in the milk shake was 0.16 and in the protein powder 0.21. The weight ratio of MFGM to ash in the milk shake was 1.3 and in the protein powder 2.7. The weight ratio of protein to ash in the milk shake was 8.5 and in the protein powder 12.6. The weight ratio of carbohydrate to protein in the milk shake was 0.9 and in the protein powder 0.1. In the milk shake, components added during manufacture may affect some of the analysis results by e.g. adding to the amount of dry matter.

TABLE 1
Compositions of high protein, high MFGM dairy based
food products. Percentages are given as wt-%.

| Component | Milk shake | Protein powder | Analysis method |
|---|---|---|---|
| Fat | 1.69% | 13.06% | ISO23318 |
| Galactose | 0.22% | N.A. | ISO 5765-2 |
| Glucose | 0.22% | N.A. | ISO 5765-1 |
| Lactose | <0.01% | N.A. | Dionex Technical |
| | | | Note 20 (2021) |
| Protein | 8.91% | 71.75% | ISO8968-1 |
| Ash | 1.05% | 5.68% | NMKL173: 2005 |
| Carbohydrates | 7.7% | 6.4% | Calculated from dry |
| | | | matter |
| Dry matter | 19.4% | 96.9% | ISO 6734 |
| Water content | 80.6% | 3.09% | IDF26A: 1993 |
| Polar lipids | 4.6 mg/g | 50.6 mg/g- | Jukkola et al (2019) |
| MFGM | 1.38% | 15.2% | Calculated from |
| | | | polar lipids |

N.A. = not analyzed.

### Example 3

### Clinical Study on Improving Physical Performance in Older Women

Sarcopenia is common in people 70+ years of age and its prevalence increases with further aging. Our objective was to test whether a dairy based food product high in both milk fat globule membrane (MFGM) and protein would improve physical performance in older women.

### Methods

Study subjects: 101 older, home-dwelling females (>70 years) were recruited to the study under inclusion and exclusion criteria presented in Table 2. Sarcopenia was screened with SARC-F questionnaire (Malmstrom et al. 2013) and subjects were excluded from the study if they scored 0 points on the questionnaire, had a diagnosed memory disorder or poor cognition Mini-Mental State Examination (MMSE) score <24 (Folstein et al. 1975) or were not able to move independently. Oral and written informed consent was obtained from the participants. The study was conducted according to the guidelines of the Declaration of Helsinki and the study protocol was approved by the Department of Medicine at Helsinki University Hospital and City of Helsinki (nr. HUS/3022/2020).

TABLE 2
Study subject inclusion and exclusion criteria.

Inclusion criteria
Home-dwelling female ≥70 years of age
SARC >0
Protein intake <1.2 g/body weight kg/d according to 3-day food diary
Subjective walking ability 400 m
Exclusion criteria
Poor cognition or neurocognitive disorder, MMSE <24
SARC = 0
High alcohol consumption (>18 portions a week or AUDIT ≥3)
Bed or wheelchair bound
Self-reported severe kidney malfunction
Acute cancer treatment in less than a year, except basal cell carcinoma
Parkinson's disease
Insulin dependent diabetes
Special diet that prevents use of the dairy
based food product provided by the study
Spends long time away from the metropolitan area during the study
Takes part of another lifestyle intervention simultaneously
Unintentional weight loss >3 kg in 3 moths
Severe obesity (BMI over 35 kg/m²)
Evaluation by the researchers that the subject
will not be able to finish the study

Study protocol: The participants were randomly assigned to intervention or to control groups using a statistician developed computer-based program. The intervention group received a dairy based food product containing MFGM and protein daily during the 12-week study. In addition, both groups were advised a simple five-movement exercise routine, which they were encouraged to independently perform daily during the study. To monitor their compliance with the advice, the participants filled a daily track sheet, where they reported whether or not they had consumed a dairy based food product and/or performed the exercise.

Advice: A trained dietician gave advice to the participants in the intervention group about the consumption of the dairy based food products provided by the study. The dietician advised the participants to replace a usually consumed snack (e.g., a bread or pastry) in their daily diet with the study product in case their BMI was >23 kg/m². If their BMI was ≤23 kg/m², the participants were encouraged to consume the dairy based food product in addition to their usual diet.

The dairy based food products: We offered two types of dairy based food products to the participants in the intervention group. One was a 250 mL chocolate milkshake and the other an individually packed 30 g protein powder. The powder and milk shake were produced from the ultrafiltered protein-hydrolyzed lactose free buttermilk concentrate as described in Examples 1 and 2. The lactose content of the buttermilk concentrate was <0.01%. The serving size of both products contained the same amount of protein (23 g) and a similar amount of MFGM (powder 3.9 g and shake 3.6 g).

Exercise routine: At the baseline visit, each participant in both groups was taught a short, five-movement exercise routine which they were encouraged to perform daily. The routine was planned to maintain muscle mass and strength of the lower extremities and it is designed by a non-governmental organization, Age Institute, which is an expert organization specialized in enhancing healthy aging (https://www.ikainstituutti.fi/in-english/). The exercise routine is available under the link: https://www.ikainstituutti.fi/content/uploads/2021/02/KAVELY_KEVYEMMAKSI_ENG_saav0.pdf

Measurements: The participants were followed up for three months. The primary outcome of the study was the difference in changes in five-time-sit-to-stand-test between the intervention and the control groups. The five-time-sit-to-stand-test was measured during baseline and end visits at three months. The test is an indicator of muscular endurance and agility and is a good predictor of mobility disability and falls in home dwelling older people. During the test, the participants stood up and sat down five times with their arms folded in front of their chest as quickly as possible on a firm chair (Jones et al. 2013). The time required to complete five cycles was measured. The test is also part of the Short Physical Performance Battery (SPPB) test, which also includes a walking speed and balance tests (Guralnik ym. 1994). The SPPB test in its' entirety was included in the measurements. Grip-strength was measured with a dynamometer (Saehan DHD-1 Digital hand dynamometer) using a standard protocol.

Cognition was measured using Trail Making Test (TMT) A and B, which test attention and psychomotoric speed (Reitan et al. 1958). TMT-B-test also requires good executive function (Reitan 1958). Health-related quality of life was assessed using RAND-36 test, which is also validated in the Finnish population. (Brazier ym 1993, Aalto ym. 1997).

Energy and protein intakes were measured using a 3-day food diary before the baseline visit to verify whether potential participants filled the inclusion criteria on protein intake (protein intake <1.2 g/kg body weight (BW)/d). In addition, 3-day food diaries were collected at the end of the trial to see whether use of dairy based food products increased protein intake and energy intakes of the participants. The participants also filled in a background questionnaire included questions on life-style habits, general health, diseases and the use of medications and dietary supplements. Height, weight, and waist circumference were measured during the baseline visit, and weight and waist circumference were also measured during the end visit. Measurements of weight and height were used to calculate body mass index (BMI kg/m²).

### Results and Discussion

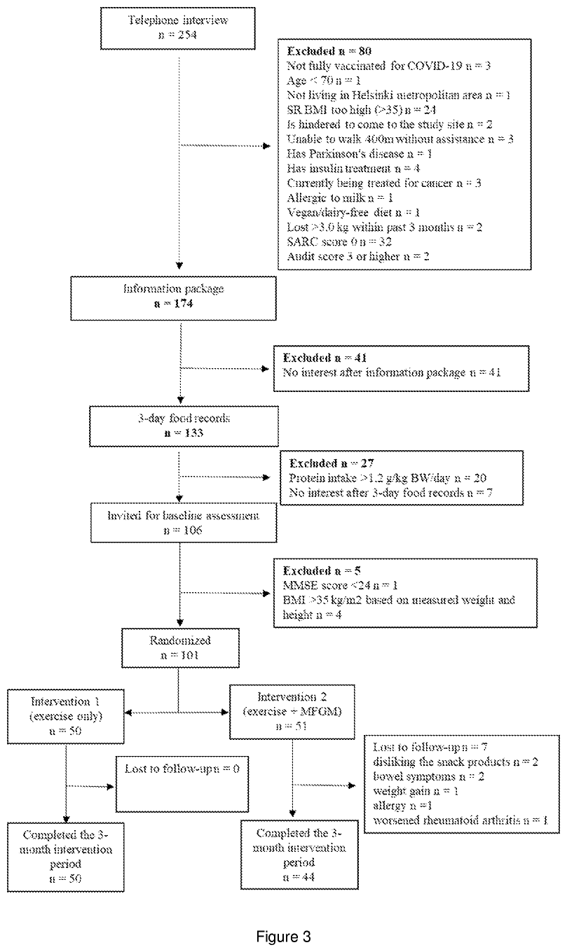

In total, we recruited 101 participants of which 94 finalized the trial (44 participants in the intervention group, 50 in the control group). The flow chart of the study is presented in FIG. 3. The intervention and the control groups were similar in most of the baseline characteristics which are presented in Table 3.

TABLE 3
Baseline characteristics of the participants
in the control and intervention groups.

| | Group | | | |
|---|---|---|---|---|
| | Control | | Intervention | |
| Characteristics | N = 50 | | N = 44 | |
| Age, mean (SD) | 76 | (4) | 75 | (4) |
| Education, n (%) | | | | |
| elementary school or less | 2 | (4) | 3 | (6) |
| vocational school | 8 | (16) | 7 | (14) |
| upper comprehensive school | 7 | (14) | 6 | (12) |
| upper secondary school | 7 | (14) | 11 | (22) |
| institute of higher education | 25 | (51) | 23 | (46) |
| Financial status, n (%) | | | | |
| good | 23 | (48) | 18 | (36) |
| moderate | 24 | (50) | 30 | (60) |
| poor | 1 | (2) | 2 | (4) |
| Smoker, n (%) | 2 | (4) | 3 | (6) |
| AUDIT, mean (SD) | 1.7 | (1.1) | 2.1 | (1.6) |
| SARC-F -score, mean (SD) | 2.3 | (0.9) | 2.2 | (1.2) |
| MMSE -score mean (SD) | 28.8 | (1.6) | 28.6 | (1.7) |
| Weight, kg, mean (SD) | 75 | (11) | 74 | (11) |
| BMI, kg/m², mean (SD) | 28.3 | (3.6) | 28.3 | (3.6) |
| Waist circumference, cm, mean (SD) | 95.6 | (11.1) | 93.0 | (10.1) |
| Energy, kcal, mean (SD) | 1559 | (275) | 1644 | (388) |
| Protein intake g, mean (SD) | 62 | (13) | 66 | (15) |
| protein g/kg BW/day | 0.85 | (0.20) | 0.90 | (0.18) |
| Protein intake <1.0 | 15 | (30) | 16 | (30) |
| g/kg BW/day, n (%) | | | | |
| Diseases during the | | | | |
| last 12 months, n (%) | | | | |
| Diabetes | 4 | (8) | 7 | (14) |
| Coronary artery disease | 4 | (8) | 4 | (8) |
| Cardiac failure | 2 | (4) | 1 | (2) |
| Arterial fibrillation | 4 | (8) | 5 | (10) |
| Other cardiac disease | 3 | (6) | 2 | (4) |
| Hypertension | 31 | (63) | 25 | (51) |
| Other transient ischemic attack | 4 | (8) | 4 | (8) |
| Foot circulatory disorder | 10 | (20) | 5 | (10) |
| Asthma | 5 | (10) | 8 | (16) |
| Osteoarthritis | 31 | (63) | 34 | (69) |
| Thyroid disease | 15 | (30) | 10 | (20) |
| Cancer | 16 | (32) | 11 | (22) |
| Number of medications, n (%) | 4.6 | (3.3) | 3.9 | (2.7) |

AUDIT = Alcohol Use Disorders Identification Test; SARC-F = Sarcopenia-Frailty questionnaire; MMSE = Mini Mental State Examination; BMI = Body mass index; BW = body weight.

The change in the five-time-sit-to-stand test did not differ between the intervention and control groups at the end of the trial (intervention −2.3 (95% CI −3.9 to −1.6) vs control-2.2 (95% CI −3.2 to −1.2), p=0.29). Thus, both groups somewhat improved in the five-time-sit-to-stand-test. However, the change in in total SPPB score differed significantly (+0.8 points (95% CI +0.5 to +1.1) in the intervention group vs. 0.2 points (95% CI −0.2 to +0.7) in the control group) favoring the intervention group (p<0.020). The improvement in the intervention group derives mainly from the improved balance test in the intervention compared with the control.

Protein intake increased significantly in the intervention group due to the intervention compared to the control group; +14 g in the intervention group (from 66 g to 80 g) vs. −1 g in the control group (from 62 g to 61 g). Similarly, protein intake as g/kg BW/d increased from 0.9 to 1.1 in the intervention group, whereas in the control group it remained constant (0.85 at baseline and 0.9 at end of trial). There was no significant change in energy intake nor participants' weights between the baseline and follow-up in either group.

Other secondary outcomes (walking speed, hand grip strength, Trail making tests A or B, health-related quality of life by RAND-36) did not change significantly due to the intervention.

In this study, the five-time-sit-to-stand-test result did not change between the intervention and control groups. Notably, our study did not include mandatory exercise. Instead, we taught all participants an exercise routine and instructed them to perform the routine daily without further supervision. The intervention participants were also advised to consume the dairy based food product after daily physical activity, which may enhance the effect of MFGM and protein. The effect of MFGM and protein supplementation might be even more pronounced with additional, more structured exercise to improve muscle strength clinically significantly. However, we wanted to test whether supplementation alone could improve physical performance and therefore, both groups were only instructed to exercise.

In the study, the participants were offered a dairy based food product high both in MFGM and protein. As the participants had low protein intake at baseline, increased protein intake may have had further benefits to physical performance related outcomes. The protein was also partially hydrolyzed, which enhances absorption and augments postprandial amino acid availability, an important regulator of muscle protein synthesis. MFGM is safe to consume at the level present in the dairy based food products and it was generally well-tolerated in our study population. The combination of MFGM and (partially hydrolyzed) protein may produce a synergistic effect in improving physical performance.

The balance tests score of the SPPB changed significantly, as well as the SPPB total score, mainly due to the balance and walking speed scores, favoring the intervention group. Balance is crucial in preventing falls and injury in older people, and it is necessary in performing daily activities and leading an independent life. Maintaining balance is a complex task that requires coordination of vestibular function, visual function, muscle strength and sensory nervous system. Improving balance by adding MFGM and protein rich dairy based food products to daily diets of older people could potentially support healthy and active aging. Benefits on balance may be achieved even without increasing exercise. In conclusion, our study suggests that the combination of MFGM and protein improved physical performance related to balance, and total SPPB score in community-dwelling older women.

### Example 3

Effect on Physical Performance of C. elegans

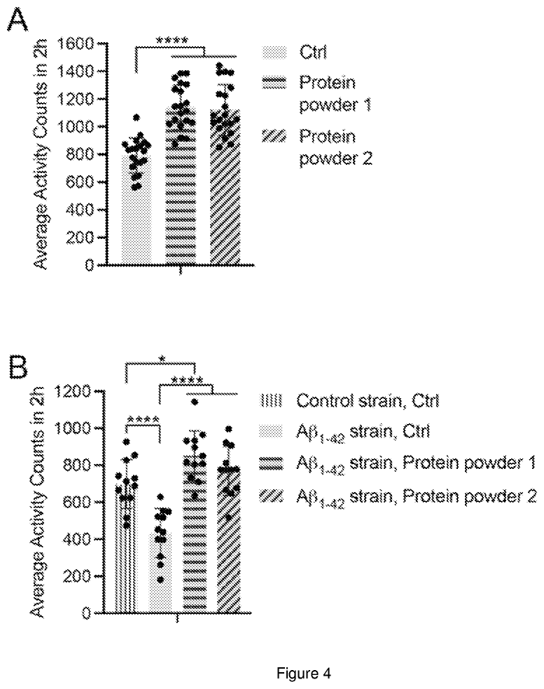

To investigate whether MFGM-containing powders affect aging-associated phenotypes in a standardized laboratory condition, we utilized the nematode Caenorhabditis elegans. C. elegans is a widely used model organism in aging research due to its conserved genome and proteome, as well as the occurrence of age-related human-like physiological changes at the tissue, cellular, and molecular level (Son et al. 2019, Tissenbaum 2015). One of the most prominent aging-associated phenotypes in C. elegans (and also in humans) is the decline of neuronal and muscular integrity, which leads to reduced activity (Son et al. 2019). To elucidate whether MFGM powders prevent this symptom of aging, we utilized wMicroTracker (InVivo Biosystems), a platform that allows automated measurement of C. elegans activity. When investigating the physical performance of day 4 adult animals (7^{th} day from hatch), a stage of life when C. elegans begins to show symptoms of aging, we found that MFGM-containing powders Protein powder 1 and Protein powder 2 significantly improve their activity (FIG. 4A). Powders 1 and 2 originate from two different manufacturing batches and have composition matching that of the protein powder in Example 2. Next, we tested whether MFGM-containing powders affect the activity of C. elegans proteotoxicity model. For this purpose, we utilized a strain expressing human amyloid beta (Ab₁₋₄₂) peptide in body-wall muscle cells, which results in reduced activity (McColl et al 2012). MFGM-containing powders were found to enhance the activity of the Ab₁₋₄₂-expressing strain (FIG. 4B), thus phenocopying the effect detected with wild-type animals (FIG. 4A). Together, these data from the model organism C. elegans demonstrate that MFGM-containing powders (Protein powder 1 and Protein powder 2) enhance the physiology of the biological system.

### REFERENCES

Aalto, A M, et al. RAND-36 item health survey (RAND-36): Yleinen terveyteen liittyvän elämänlaadun mittari. Suomen Lääkärilehti. 1997; 52:1065.
Brazier J, et al. Testing the validity of the Euroqol and comparing it with the SF-36 health survey questionnaire. Quality of Life Research. 1993; 2:169-80.
Dionex Technical Note 20: Carbohydrate analysis by high-performance anion-exchange chromatography with pulsed amperometric detection (HPAE-PAD), Thermo Fisher Scientific. 2021.
Folstein M F et al. “Mini-mental state”. A practical method for grading the cognitive state of patients for the clinician. J Psychiatr Res. 1975; 12:189-98.
Guralnik J M et al. A short physical performance battery assessing lower extremity function: association with self-reported disability and prediction of mortality and nursing home admission. J Gerontol. 1994 March; 49 (2): M85-94.
Jones S E et al. The five-repetition sit-to-stand test as a functional outcome measure in COPD. Thorax. 2013; 68:1015-20.
Jukkola, A. et al. Changes in milk fat globules and membrane lipids under the shear fields of microfiltration and centrifugation. J. Membr. Sci. 2019, 573, 218-225.
Malmstrom T K et al. SARC-F: a symptom score to predict persons with sarcopenia at risk for poor functional outcomes. J Cachexia Sarcopenia Muscle. 2013; 7:28-36.
Matsubara et al. Crystalline bacterial proteinase II. General properties of crystalline proteinase of Bacillus subtilis N′, J. Biochem. 45 (4) (1958) 251-258.
McColl, G. et al. Utility of an improved model of amyloid-beta (Aβ₁₋₄₂) toxicity in Caenorhabditis elegans for drug screening for Alzheimer's disease. Mol. Neurodegener. 2012, 7, 57.
Reitan R M. Validity of the Trail Making Test as an Indicator of Organic Brain Damage. Percep Motor Skills. 1958; 3:271-6.
Son, H. G., Altintas, O., Kim, E. J. E., Kwon, S. & Lee, S.-J. V. Age-dependent changes and biomarkers of aging in Caenorhabditis elegans. Aging Cell 2019, 18, e12853.
Tissenbaum, H. A. Using C. elegans for aging research. Invertebr Reprod Dev. 2015, 59, 59-63.

1. A milk product comprising a content of milk protein in dry matter of at least 30% by weight and a content of milk fat globule membrane (MFGM) in dry matter of at least 3% by weight, wherein the milk protein is partially hydrolysed, wherein extent of milk protein hydrolysis is at least 2 mg free tyrosine/g protein.

2. The milk product according to claim 1, comprising a lactose content of less than 1% by weight.

3. (canceled)

4. The milk product according to claim 1, wherein extent of protein hydrolysis is in the range of 3 to 50 mg free tyrosine/g protein.

5. The milk product according to claim 1, comprising a MFGM to protein weight ratio in the range of 0.05 to 0.4.

6. The milk product according to claim 1, comprising a content of milk protein in dry matter in the range of 30% to 90% by weight.

7. The milk product according to claim 1, comprising a content of MFGM in dry matter in the range of 3% to 30% by weight.

8. The milk product according to claim 1, comprising a protein to ash weight ratio in the range of 3.0 to 25.

9. The milk product according to claim 1, comprising a MFGM to ash weight ratio in the range of 0.6 to 10.

10. The milk product according to claim 1, comprising a protein to fat weight ratio in the range of 3 to 10.

11. The milk product according to claim 1, comprising a carbohydrate to protein weight ratio of 0.9 or less.

12. A dairy based food product comprising the milk product or manufactured from the milk product according to claim 1.

13-17. (canceled)

18. A method for producing a milk product comprising a content of milk protein in dry matter of at least 30% by weight and a content of MFGM in dry matter of at least 3% by weight, wherein the method comprises subjecting a milk raw material comprising milk protein and MFGM to ultrafiltration and collecting an ultrafiltration retentate, and partially hydrolysing the milk protein comprised in the ultrafiltration retentate, wherein extent of milk protein hydrolysis is at least 2 mg free tyrosine/g protein.

19. The method according to claim 18, wherein ultrafiltration comprises a step of diafiltration.

20. The method according to claim 18, wherein the product has a lactose content of less than 1% by weight.

21-23. (canceled)

24. The method according to claim 18, wherein lactose in the ultrafiltration retentate is hydrolysed simultaneously with protein hydrolysis.

25. The method according to claim 18, wherein extent of protein hydrolysis is in the range of 3 to 50 mg free tyrosine/g protein.

26. The method according to claim 18, wherein the milk product comprises a MFGM to protein weight ratio in the range of 0.05 to 0.4.

27. The method according to claim 18, wherein the milk product comprises a content of milk protein in dry matter in the range of 30% to 90% by weight.

28. The milk product according to claim 18, wherein the milk product comprises a content of MFGM in dry matter in the range of 3% to 30% by weight.

29. The method according to claim 18, wherein the milk product comprises a protein to ash weight ratio in the range of 3.0 to 25.

30. The method according to claim 18, wherein the milk product comprises a MFGM to ash weight ratio in the range of 0.6 to 10.

31. The method according to claim 18, wherein the milk product comprises a protein to fat weight ratio in the range of 3 to 10.

32. The method according to claim 18, wherein the milk product comprises a carbohydrate to protein weight ratio of 0.9 or less.

33. The method according to claim 18, wherein the milk raw material is buttermilk or lactose-free buttermilk.

34. The method according to claim 18, wherein comprising subjecting the ultrafiltration retentate to extended shelf life (ESL) treatment and homogenisation to produce a dairy based food product.

35. The method according to claim 18, comprising subjecting the ultrafiltration retentate to one or more of evaporation and spray drying to produce a powder.

36-48. (canceled)

49. A method of improving or maintaining physical performance in a subject, comprising administering to the subject the milk product according to claim 1 or a dairy based food product manufactured from the milk product according to claim 1 or a dairy based food product comprising the milk product according to claim 1.

50-59. (canceled)

60. The method according to claim 49, wherein improving or maintaining physical performance comprises one or more of a) to h):
a) Improving or maintaining mobility,
b) Improving or maintaining balance,
c) Improving or maintaining ambulatory activity,
d) Improving or maintaining physical agility,
e) Alleviating or preventing sarcopenia,
f) Improving or maintaining one or more of muscle strength, muscle mass, muscle density, muscle function, and muscle fiber velocity,
g) Improving or maintaining weight control, or
h) Alleviating or reducing the risk of one or more of mobility disability, falling, poor physical function, deterioration of muscle mass, deterioration of strength, decline in quality of life, institutionalization, and premature death.

61. The method according to claim 49, wherein the subject is a human subject.
